(19) United States
(12) Patent Application Publication
(10) Pub. No.: US 2006/0200705 A1
(43) Pub. Date: Sep. 7, 2006

(54) Method, system and program product for monitoring a heartbeat of a computer application

(75) Inventors: Ernest J. Burger, Highland, NY (US); Maria T. Kapogiannis, Poughkeepsie, NY (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/073,793

(22) Filed: Mar. 7, 2005

(51) Int. Cl. G06F 11/00

(52) U.S. Cl. 714/47

(57) ABSTRACT

Under the present invention, parameters and configuration information (e.g., a file) for the monitoring process are read. Among other things, the configuration information specifies names of message queues for applications to be monitored. Thereafter, heartbeat messages are published to the message queues specified in the configuration information. If the heartbeat messages are not read within an expiration time period (as also specified in the configuration information), they are placed in an error queue for handling by an error handler.

### FIELD OF THE INVENTION

In general, the present invention relates to heartbeat monitoring. Specifically, the present invention relates to a method, system and program product for monitoring a heartbeat of a computer application.

### BACKGROUND OF THE INVENTION

As the pervasiveness of computer applications (hereinafter “applications) continues to grow. There is a growing need to be able to monitor a “heartbeat” of applications implemented within a computer environment. For example, a given environment might have several applications intended to operate at any particular time. However, it could be the case that one or more of these applications is experiencing an error condition that prevents proper operation. Given that a number of applications could be implemented within the environment, testing to ensure proper operation of individual applications can be complicated.

Currently, many environments implement messaging schemes to facilitate communication among the applications or components of the environment. One popular scheme is known as MQSeries messaging, which is commercially available from International Business Machines Corp. of Armonk N.Y. Under MQSeries, an application can utilize one or more message queues for handling messages. In general, messages are published to the messages queues, which are then read in order by the corresponding/associated applications. These queues are typically managed by a queue manager.

Unfortunately, no existing system takes advantage of existing messaging and queue technology in evaluating the functionality of an application. That is, no existing system has devised a way to utilize messaging queues in order to determine the operation of applications in the environment. In view of the foregoing, there exists a need for a method, system and program product for monitoring a heartbeat of a computer application. Specifically, a need exists for a system that utilizes existing messaging queues to determine if applications existing within a computer environment are operating.

### SUMMARY OF THE INVENTION

In general, the present invention provides a method, system and program product for monitoring a heartbeat of a computer application. Specifically, under the present invention, parameters and configuration information (e.g., a file) for the monitoring process are read. Among other things, the configuration information specifies names of message queues for applications to be monitored. Thereafter, heartbeat messages are published to the message queues specified in the configuration information. If the heartbeat messages are not read within an expiration time period (as also specified in the configuration information), they are placed in an error queue for handling by an error handler.

A first aspect of the present invention provides a method for monitoring a heartbeat of a computer application, comprising: reading configuration information that identifies at least one queue to be monitored for the computer application; publishing a heartbeat message to the at least one queue based on a predetermined time interval specified in the configuration information; and placing the heartbeat message in an error queue if the heartbeat message is not read by the computer application within a predetermined expiration time specified in the configuration information.

A second aspect of the present invention provides a system for monitoring a heartbeat of a computer application, comprising: a system for reading configuration information that identifies at least one queue to be monitored for the computer application; and a system for publishing a heartbeat message to the at least one queue based on a predetermined time interval specified in the configuration information, wherein the heartbeat message is placed in an error queue if the heartbeat message is not read by the computer application within a predetermined expiration time specified in the configuration information.

A third aspect of the present invention provides a program product stored on a computer readable medium for monitoring a heartbeat of a computer application, the computer readable medium comprising program code for performing the following steps: reading configuration information that identifies at least one queue to be monitored for the computer application; and publishing a heartbeat message to the at least one queue based on a predetermined time interval specified in the configuration information, wherein the heartbeat message is placed in an error queue if the heartbeat message is not read by the computer application within a predetermined expiration time specified in the configuration information.

A fourth aspect of the present invention provides a method for deploying an application for monitoring a heartbeat of a computer application, comprising: providing a computer infrastructure being operable to: read configuration information that identifies at least one queue to be monitored for the computer application; publish a heartbeat message to the at least one queue based on a predetermined time interval specified in the configuration information; and place the heartbeat message in an error queue if the heartbeat message is not read by the computer application within a predetermined expiration time specified in the configuration information.

A fifth aspect of the present invention provides computer software embodied in a propagated signal for monitoring a heartbeat of a computer application, the computer software comprising instructions to cause a computer system to perform the following functions: read configuration information that identifies at least one queue to be monitored for the computer application; publish a heartbeat message to the at least one queue based on a predetermined time interval specified in the configuration information; and place the heartbeat message in an error queue if the heartbeat message is not read by the computer application within a predetermined expiration time specified in the configuration information.

Therefore, the present invention provides a method, system and program product for monitoring a heartbeat of a computer application.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system for monitoring a heartbeat of a computer application according to the present invention.

FIG. 2 depicts the movement of a heartbeat message to an error queue according to the present invention.

FIG. 3 depicts a flow diagram according to the present invention

FIG. 4 depicts a more specific computerized implementation of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### BEST MODE FOR CARRYING OUT THE INVENTION

For convenience purposes, the Best Mode for Carrying Out the Invention will have the following sections:

I. General Description

II. Computerized Implementation

I. General Description

As indicated above, the present invention provides a method, system and program product for monitoring a heartbeat of a computer application. Specifically, under the present invention, parameters and configuration information (e.g., a file) for the monitoring process are read. Among other things, the configuration information specifies names of message queues for applications to be monitored. Thereafter, heartbeat messages are published to the message queues specified in the configuration information. If the heartbeat messages are not read within an expiration time period (as also specified in the configuration information), they are placed in an error queue for handling by an error handler.

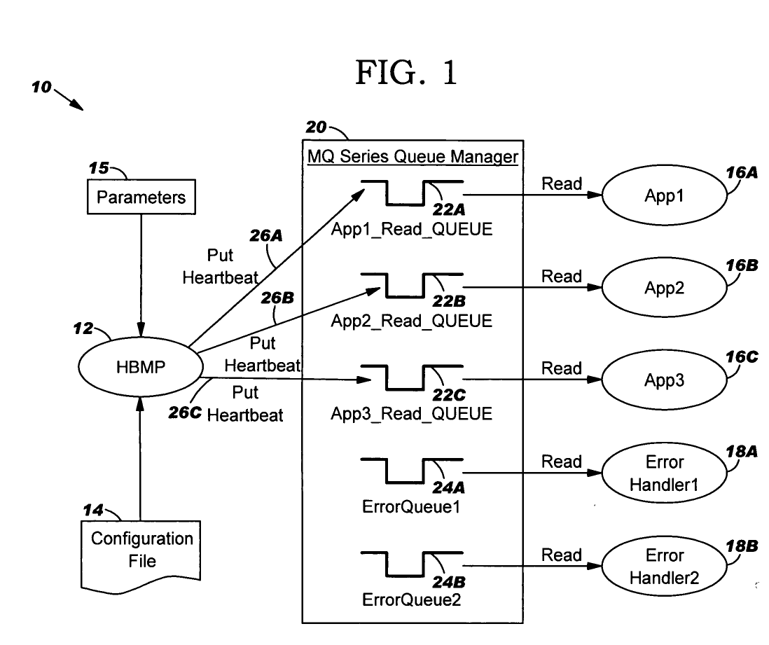

Referring now to FIG. 1, a system 10 for monitoring a heartbeat of one or more (computer) applications is shown. Specifically, under the repent invention, heart beat monitoring program (HBMP) 12 is provided to monitor the “heartbeat” of one or more applications 16A-C. As used herein, the term “heartbeat” is used to describe whether applications 16A-C are operational or at least functioning as intended. As also shown in FIG. 1, a set of applications queues 22A-C and error queues 24A-B are provided and are managed by queue manager 20. In a typical embodiment, queues 22A-C and 24A-B are MQSeries queues and queue manager 20 is an MQSeries Queue Manager. However, it should be understood that this need not be the case, and that any type of queues and queue manager now known or later developed could be used within the scope of the present invention.

Under the present invention, HBMP 12 will utilize configuration file 14 and parameters 15 to monitor applications 16A-C. Configuration file 14 contains configuration information (e.g., in rows) indicating exactly how queues 22A-C and 24A-B should be manipulated to provide heartbeat monitoring of applications 16A-C. That is, configuration file 14 is used to configure the HBMP 12. In a typical embodiment, each row of configuration file 14 corresponds to a single application 16A-C. Thus, a row is added to configuration file 14 for each application desired to be monitored.

In general, the format of configuration file 14 is a series of positional values separated by a semicolon (;) or the like. Listed below is an illustrative description of each of the keyword values of configuration file 14.
(1) ApplicationName: This is any unique name within a list of applications to monitor.
(2) HeartbeatInterval (e.g., in minutes): This is the predetermined time interval at which the HBMP 12 will publish a heartbeat to an application.
(3) Host: This is the name of the host where the (MQSeries) Queue Manger 20 resides for the read queue of the application.
(4) Channel: This is the name of the channel used by the (MQseries) Queue Manager 20 to communicate with the HBMP 12.
(5) Port: This is the port number on which the (MQSeries) Queue Manger 20 is listening.
(6) QueueManager: This is the name of the (MQSeries) Queue Manger 20 which manages the queue that the application will read from.
(7) HeartbeatQ: This is the name of the queue on which the HBMP 12 will put the heartbeat message.
(8) ReplyToQ: This is the name of the error queue on which the heartbeat message will be placed if it expires, because the application was unable to read the message before it expired.
(9) MsgExpiry (e.g., in tenths of a second): This is the predetermined expiration time the heartbeat message will sit in the HeartbeatQ, before it expires.

Shown below is an illustrative configuration file 14 for three applications 16A-C:

App1;1;server1;SYS.DEF.SVRCONN;16100;QM1;App1.Que;
App1ERR_Q;300
App2;1;server1;SYS.DEF.SVRCONN;16100;QM1;App2.Que;
App2ERR_Q;600
App3;10;server2;SYS.DEF.SVRCONN;16100;QM3;App3.Que;
App3ERR_Q;9000

As indicated above, HBMP 12 will also utilize a set of parameters to monitor applications 16A-C. In a typical embodiment, the parameters include the following arguments:
(1) Argument 1: Name of the configuration file 14 as described above.
(2) Argument 2: predetermined time delay (e.g., time interval the HBMP 12 sleeps milliseconds)
(3) Argument 3: (optional) log filename for results of the monitoring process.
   Once HBMP 12 is started, it will read the information from the configuration file 14 (as identified in Argument 1 of parameters 15) into a local hash table. The hash table is then read, at an interval defined by the predetermined time delay set forth in Argument 2 of parameters 15. In reading the hash table, HBMP 12 will read each row thereof to decide if it should publish a heartbeat message 26A-C for a given application 16A-C. As shown in the above illustrative configuration file, applications 16A-C have predetermined time intervals of one minute, one minute and ten minutes, respectively.

If the time difference between the current system time, and the last time a heartbeat message was sent to an application is greater than or equal to the predetermined time interval defined in configuration file 14, then HBMP 12 will publish a heartbeat message 26A-C to the corresponding application queue 22A-C, and update the hash table with the timestamp of the heartbeat message 26A-C that it just published. Shown below is illustrative code showing the determination of whether a heartbeat message 26A-C should be published to an application queue for an application.

```
If (CurrentTime − LastHeartbeatTime >= HeartbeatInterval) {
  Then publish a heartbeat to the application
  Update hash table with the current time of the heartbeat just sent.
} Else {
  Read the next row in the hash table and process it
}
```

If HBMP 12 determines that a heartbeat message 26A-C should be published to an application queue 22A-C, it forms an XML message (shown below) with the following syntax, and publishes it to the appropriate application queue as define in the configuration file 14.

```
<GTC>
  <Response>
    <Command>Heartbeat</Command>
    <Originator>HBMP</Originator>
    <Application> + applicationName + </Application>
    <Host> + host + </Host>
    <Channel> + channel + </Channel>
    <Port> + port + </Port>
    <QManager> + queueManager + </QManager>
    <HeartbeatQ> + heartbeatQ + </HeartbeatQ>
    <ReplyToQ> + replyToQ + </ReplyToQ>
    <HeartbeatInterval> + heartbeatInterval + </HeartbeatInterval>
    <LastHeartbeat> + lastHeartbeat + </LastHeartbeat>
  </Response>
</GTC>
```

Assume in an illustrative example that HBMP 12 determined that a heartbeat message 26A was needed for application 16A. In this case, a heartbeat message 26A such as the above would be published to application queue 22A. It should be understood that a one-to-one relationship of application queues 22A-C to applications 16A-C is shown in FIG. 1 for illustrative purposes only. That is, multiple applications could read and/or put from the same application queue. In any event, once all the rows in the hash table are processed, HBMP 12 will “go to sleep” for the predetermined time defined in Argument 2 of parameters 15. Once the delay expires, the HBMP 12 will “wake up” and repeat the procedure of processing and sleeping, until the program is stopped.

Further assume in this example that application 16A failed to read the heartbeat message 26A in application queue 22A within the predetermined expiration time (e.g., 300 milliseconds in the above illustrative configuration file). In such a case, HBMP 12 or queue manager 20 will place/move the heartbeat message 26A to an error queue (e.g., error queue 24A) for handling by an error handler (e.g., error handler 18A). Also, if a log file was specified in Argument 3 of parameters 15, then results of the monitoring process will be published thereto.

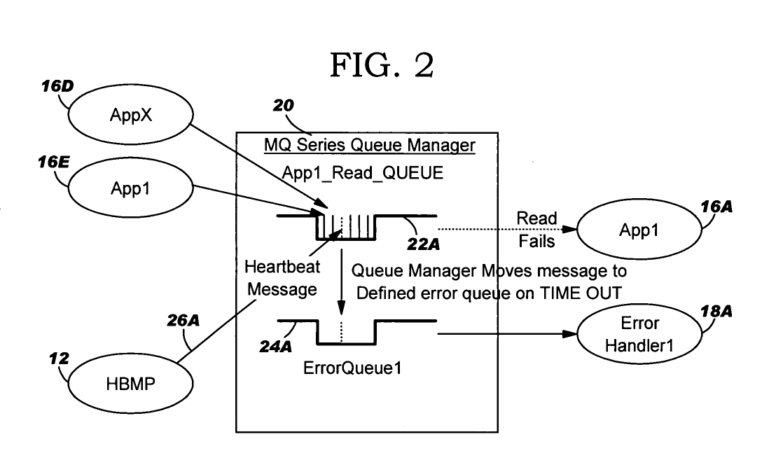

Referring now to FIG. 2, this process is shown in greater detail. As depicted in FIG. 2, multiple applications 16A and 16D-E utilize application queue 22A. Specifically, applications 16D-E put messages on application queue 22A, while application 16A reads from application queue 22A. As further shown, application 16A has failed to reach the heartbeat message 26A published to application queue 22A within the predetermined expiration time. As such, queue manager 20 has moved the heartbeat message 26A to error queue 24A for handling by error handler 18A.

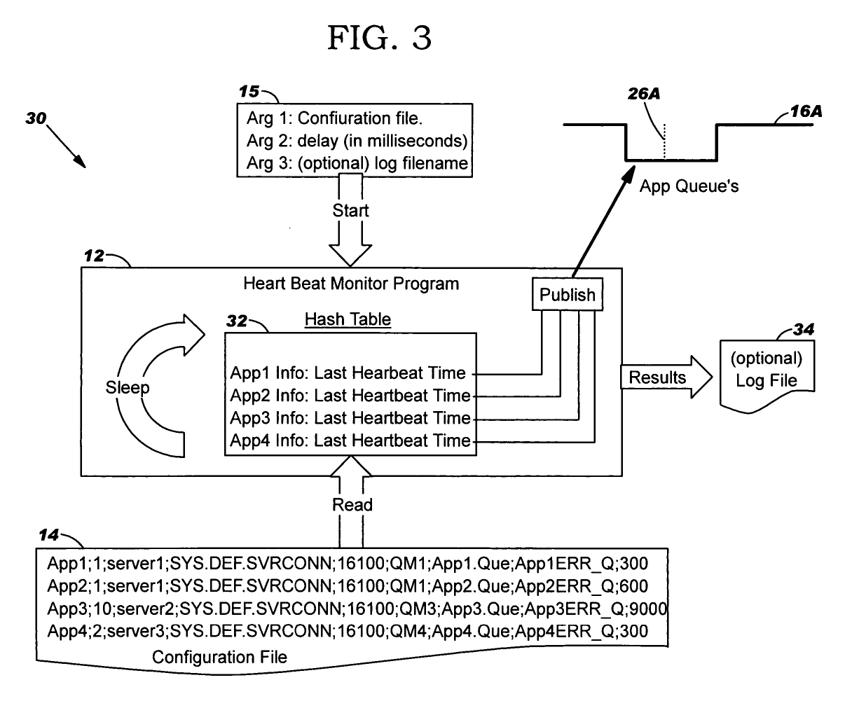

Referring now to FIG. 3, a flow diagram 30 of the monitoring process of the present invention is shown. As depicted, HBMP 12 will receive configuration file 14 and parameters 15. The configuration file 14 identified in Argument 1 of parameters 15 is read into a local hash table 32, which is then processed according to the predetermined time delay set forth in Argument 2 of parameters 15. Based on the configuration information contained in hash table 32 (e.g., the predetermined time intervals), heartbeat messages can be published to the application queues (e.g., application queue 16A). If the heartbeat messages are not read by the associated application within the respective predetermined expiration times, the heartbeat messages are moved to one or more error queues for processing by one or more error handlers. If an output log was specified in parameters 15, then results of the monitoring process (e.g., heartbeat message successfully read, heartbeat not successfully read, etc.) can be output/published to an output log 34. Once the hash table 32 has been processed completely, HBMP 12 will “sleep” for the predetermined time delay specified in Argument 2 of parameters 15, at which point it will “wake up” and repeat the process.

II. Computerized Implementation

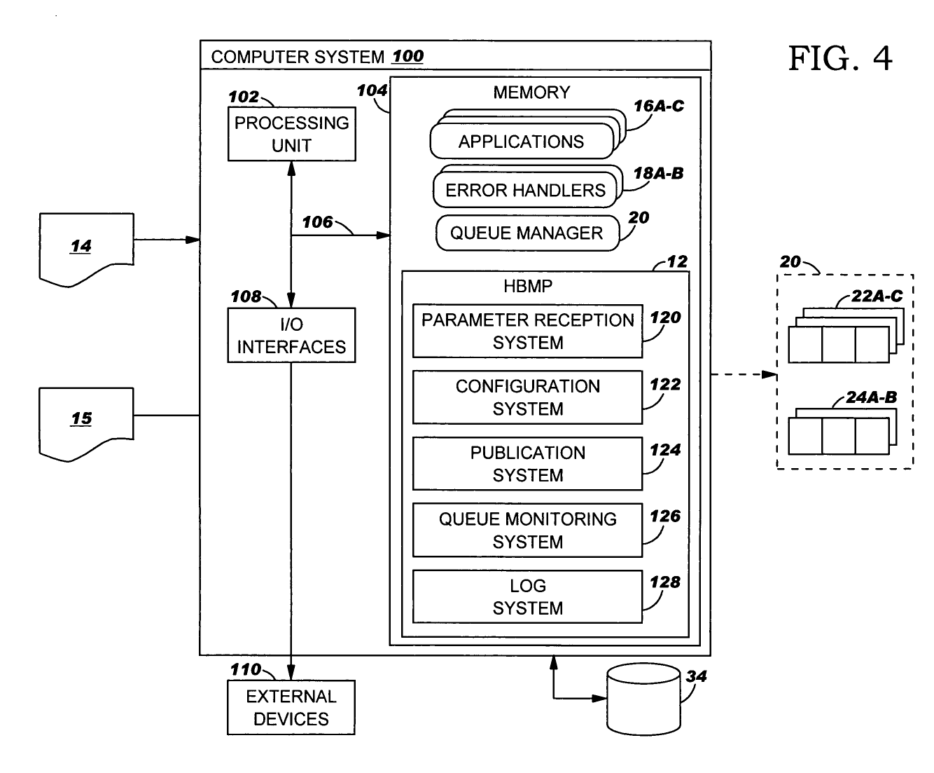

Referring now to FIG. 4, a more specific computerized implementation of the present invention is shown. As depicted, a computer system 100 is provided on which HBMP 12, applications 16A-C, queue manager 20, queues 22A-C and 24A-B and error handlers 18A-B are loaded. It should be understood that although each of these components is shown loaded on a single stand-alone computer system as shown, this need not be the case. Rather, one or more these components could be loaded on two or more computer systems that communicate over a network such as the Internet, a local area network (LAN), a wide area network (WAN), a virtual private network (VPN), etc. In such an embodiment, communication throughout the network could occur in a client-server or server-server environment via a direct hardwired connection (e.g., serial port), or via an addressable connection that may utilize any combination of wireline and/or wireless transmission methods. Conventional network connectivity, such as Token Ring, Ethernet, WiFi or other conventional communications standards could be utilized. Moreover, connectivity could be provided by conventional TCP/IP sockets-based protocol. In this instance, an Internet service provider could be utilized to establish connectivity.

In any event, a depicted, computer system 100 generally includes processing unit 102, memory 104, bus 106, input/output (I/O) interfaces 108, and external devices/resources 110. Processing unit 102 may comprise a single processing unit, or be distributed across one or more processing units in one or more locations, e.g., on a client and server. Memory 104 may comprise any known type of data storage and/or transmission media, including magnetic media, optical media, random access memory (RAM), read-only memory (ROM), a data cache, a data object, etc. Moreover, similar to processing unit 102, memory 104 may reside at a single physical location, comprising one or more types of data storage, or be distributed across a plurality of physical systems in various forms.

I/O interfaces 108 may comprise any system for exchanging information to/from an external source. External devices/resources 110 may comprise any known type of external device, including speakers, a CRT, LED screen, hand-held device, keyboard, mouse, voice recognition system, speech output system, printer, monitor/display, facsimile, pager, etc. Bus 106 provides a communication link between each of the components in computer system 100 and likewise may comprise any known type of transmission link, including electrical, optical, wireless, etc.

Output log 34 can be any type of system (e.g., database, a file, etc.) capable of providing storage for data (e.g., configuration files 14, parameters 15, application monitoring results, etc.) under the present invention. As such, output log 34 could include one or more storage devices, such as a magnetic disk drive or an optical disk drive. In another embodiment, output log 34 includes data distributed across, for example, a local area network (LAN), wide area network (WAN) or a storage area network (SAN) (not shown). Although not shown, additional components, such as cache memory, communication systems, system software, etc., may be incorporated into computer system 100.

As depicted, HBMP 12, includes parameter reception system 120, configuration system 122, publication system 124, queue monitoring system 126 and log system 128. These systems perform the functions described above. Specifically, parameters 15 are read/received by parameter reception system 120. Based on the arguments therein, configuration file 14 is identified and read by configuration system 122. Specifically, configuration system 122 will read the configuration information in configuration file 14 into a hash table. Once the predetermined time delay set forth in parameters 14 expires, configuration system 122 will read the hash table. By comparing the current system time to times at which previous heartbeat messages were published to application queues 16A-C, publication system 124 can determine whether a new heartbeat message(s) should be published. Assume in this example, that publication system 124 has determined that application queue 22A requires a new heartbeat message. In this case, publication system 124 will develop/create the heartbeat message (or retrieve a previously created heartbeat message from storage), and publish the same to application queue 22A.

Once the heartbeat message has been published, queue monitoring system 126 will monitor application queue 16A (as well as any other queues on which heartbeat message have been published) to determine whether application 16A reads the heartbeat messages within the predetermined expiration time specified in the hash table. If so, log system 128 can publish the positive results to output log 34 (e.g., if identified in parameters 15). However, if the heartbeat message was not read in time, queue monitoring system 126 can move the heartbeat message to an error queue (e.g., error queue 24A) for handling by an error handler (e.g., error handler 18A). Alternatively, queue monitoring system 126 can instruct queue manager 20 to move the heartbeat message to an error queue. In any event, thereafter, results indicating as much can be published to log 34 by log system 128. As mentioned above, once hash table has been completely processed, HBMP 12 will “sleep” until the predetermined time delay indicated in parameters 15 elapses at which point HBMP will “wake up” and the process will repeat.

It should be appreciated that the present invention could be offered as a business method on a subscription or fee basis. For example, HBMP 12, queue manager 20, queues 22A-C or 24A-B, computer system 100, etc. could be created, supported, maintained and/or deployed by a service provider that offers the functions described herein for customers. That is, a service provider could offer to monitor heartbeats of applications for customers.

It should also be understood that the present invention could be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For example, HBMP 12 is shown with a certain configuration of sub-systems for illustrative purposes only.

We claim:

1. A method for monitoring a heartbeat of a computer application, comprising:
reading configuration information that identifies at least one queue to be monitored for the computer application;
publishing a heartbeat message to the at least one queue based on a predetermined time interval specified in the configuration information; and
placing the heartbeat message in an error queue if the heartbeat message is not read by the computer application within a predetermined expiration time specified in the configuration information.

2. The method of claim 1, further comprising receiving a set of parameters prior to the reading step, wherein the set of parameters includes a name of a configuration file containing the configuration information to be read, and a predetermined time delay for reading the configuration file, and wherein the method is repeated upon expiration of the predetermined time delay.

3. The method of claim 2, wherein the reading step further comprises reading the configuration file into a hash table.

4. The method of claim 2, wherein the configuration file contains a plurality of rows of configuration information, wherein each of the set of rows pertains to one of a plurality of computer applications.

5. The method of claim 1, wherein the configuration information identifies a name of the computer application, the predetermined time interval, a host name, a channel name, a port number, a queue manager name, a name of the at least one queue, a name of the error queue, and the predetermined expiration time.

6. The method of claim 1, further comprising publishing results of the method to a log.

7. The method of claim 1, further comprising processing the error queue with an error handler.

8. A system for monitoring a heartbeat of a computer application, comprising:
a system for reading configuration information that identifies at least one queue to be monitored for the computer application; and
a system for publishing a heartbeat message to the at least one queue based on a predetermined time interval specified in the configuration information, wherein the heartbeat message is placed in an error queue if the heartbeat message is not read by the computer application within a predetermined expiration time specified in the configuration information.

9. The system of claim 8, further comprising a system for receiving a set of parameters, wherein the set of parameters includes a name of a configuration file containing the configuration information, and a predetermined time delay for reading the configuration information.

10. The system of claim 9, wherein the system for reading further reads the configuration file into a hash table.

11. The system of claim 9, wherein the configuration file contains a plurality of rows of configuration information, wherein each of the set of rows pertains to one of a plurality of computer applications.

12. The system of claim 8, wherein the configuration information identifies a name of the computer application, the predetermined time interval, a host name, a channel name, a port number, a queue manager name, a name of the at least one queue, a name of the error queue, and the predetermined expiration time.

13. The system of claim 8, further comprising a system for publishing results to a log.

14. The system of claim 8, further comprising an error handler for processing the error queue.

15. A program product stored on a computer readable medium for monitoring a heartbeat of a computer application, the computer readable medium comprising program code for performing the following steps:
reading configuration information that identifies at least one queue to be monitored for the computer application; and
publishing a heartbeat message to the at least one queue based on a predetermined time interval specified in the configuration information, wherein the heartbeat message is placed in an error queue if the heartbeat message is not read by the computer application within a predetermined expiration time specified in the configuration information.

16. The program product of claim 15, wherein the computer readable medium further comprises program code for performing the following step:
receiving a set of parameters, wherein the set of parameters includes a name of a configuration file containing the configuration information, and a predetermined time delay for reading the configuration information.

17. The program product of claim 16, wherein the computer readable medium further comprises program code for performing the following step:
reading the configuration file into a hash table.

18. The program product of claim 16, wherein the configuration file contains a plurality of rows of configuration information, wherein each of the set of rows pertains to one of a plurality of computer applications.

19. The program product of claim 15, wherein the configuration information identifies a name of the computer application, the predetermined time interval, a host name, a channel name, a port number, a queue manager name, a name of the at least one queue, a name of the error queue, and the predetermined expiration time.

20. The program product of claim 15, wherein the computer readable medium further comprises program code for performing the following step:
publishing results to a log.

21. A method for deploying an application for monitoring a heartbeat of a computer application, comprising:
providing a computer infrastructure being operable to:
read configuration information that identifies at least one queue to be monitored for the computer application;
publish a heartbeat message to the at least one queue based on a predetermined time interval specified in the configuration information; and
place the heartbeat message in an error queue if the heartbeat message is not read by the computer application within a predetermined expiration time specified in the configuration information.
